(19) United States
(12) Patent Application Publication
(10) Pub. No.: US 2003/0046535 A1
(43) Pub. Date: Mar. 6, 2003

(54) System and method for authenticating use of a network appliance

(76) Inventor: Dean S. Nelson, Meridian, ID (US)

Correspondence Address: HEWLETT-PACKARD COMPANY, Intellectual Property Administration, P.O. Box 272400, Fort Collins, CO, 80527-2400, US

(21) Appl. No.: 09/947,831

(22) Filed: Sep. 6, 2001

(51) Int. Cl. H04L 9/00

(52) U.S. Cl. 713/155

(57) ABSTRACT

The present disclosure relates to a system and method for authenticating use of a network appliance. In some arrangements, the system and method involve receiving a use request from a user, forwarding the request to an authentication agent configured to determine whether the user is authorized to use the network appliance, receiving an indication from the authentication agent as to whether the user is authorized, and enabling or disabling use of the network appliance by the user based upon the indication received from the authentication agent.

### FIELD OF THE INVENTION

The present disclosure relates to a system and method for authenticating use of a network appliance. More particularly, the disclosure relates to a simplified system and method in which authenticating use of a network appliance is standardized for substantially all appliances and operating environments.

### BACKGROUND OF THE INVENTION

In many settings, the services provided by devices can only be accessed if the user has adequate authorization. For instance, it is common in office settings for users to be required to provide authentication information before a shared device (e.g., printer) can be utilized. These sorts of authentication procedures are typically controlled by an underlying system that forms the operating environment. In such environments, various code normally is provided on the device to enable authentication. Therefore, such devices typically are required to have a level of complexity beyond that associated with their basic functionality.

Recently, there has been growing interest in so-called “network appliances” which comprise simplified machines that can be accessed and used via a network. Due to their simplicity, it can be difficult to provide security over use of the appliances' services in that, to provide such simplicity, it is desirable to not provide authentication code on the appliance itself. In particular, problems arise when, as now, various different types of operating environments exist, each having its own discrete method of authenticating users. In terms of the appliance manufacturer, disadvantages of such systems include the development, implementation, and maintenance of the code to be provided on the appliance as well as the challenge of maintaining the simplicity of the appliance while still providing the desired security. In terms of the user, disadvantages include the disparate nature of the different authentication schemes and the lack of standardization it creates. Furthermore, challenges arise for the user where the appliance is to be taken from one environment and placed in another environment in that attendant reconfiguration of the appliance may be necessary.

From the foregoing, it can be appreciated that it would be desirable to have a simplified system and method for authenticating use of a network appliance which avoids one or more of the problems identified above.

### SUMMARY OF THE INVENTION

The present disclosure relates to a system and method for authenticating use of a network appliance. In one arrangement, the system comprises means for receiving a use request from a user, means for transmitting the request to an authentication agent configured to determine whether the user is authorized to use the network appliance, means for receiving an indication from the authentication agent as to whether the user is authorized, and means for enabling or disabling use of the network appliance by the user based upon the indication received from the authentication agent.

In one arrangement, the method comprises the steps of receiving a use request from a user, forwarding the request to an authentication agent configured to determine whether the user is authorized to use the network appliance, receiving an indication from the authentication agent as to whether the user is authorized, and enabling or disabling use of the network appliance by the user based upon the indication received from the authentication agent.

Other systems, methods, features, and advantages of the invention will become apparent upon reading the following specification, when taken in conjunction with the accompanying drawings.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a schematic view of a general authentication scheme of the invention.

FIG. 2 is a schematic view of an example system for authenticating use of a network appliance.

FIG. 3 is a schematic view of a network appliance shown in FIG. 2.

FIG. 4 is a schematic view of an authentication server shown in FIG. 2.

FIG. 5 is a flow diagram that illustrates the operation of an authentication intermediary of the network appliance shown in FIG. 3.

FIG. 6 is a flow diagram that illustrates the operation of an authentication agent of the authentication server shown in FIG. 4.

FIG. 7 is a flow diagram that illustrates the operation of a billing agent of the authentication server shown in FIG. 4.

### DETAILED DESCRIPTION

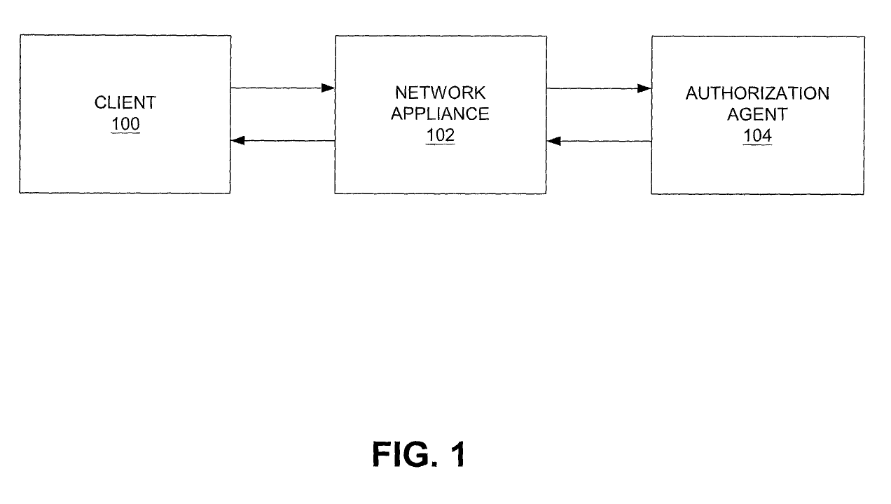

As noted above, the nature of conventional authentication systems may be dependent upon the underlying operational environment in which the systems are used. In addition, such systems are not well-suited for use with simple network appliances. Accordingly, presently contemplated is a system and method for authenticating use of a network appliance that is independent of the configuration of network appliance as well as the operational environment in which it is used. FIG. 1 illustrates the general authentication scheme of the system and method. As indicated in this figure, a client 100 can attempt to access and use a network appliance 102. Instead of confirming the client's authorization to use the network appliance 102, the appliance forwards (e.g., transmits) the use request to a authentication agent 104 that is charged with confirming authorization to use the appliance. Once such authorization is confirmed, it is communicated to the network appliance 102 and, ultimately, to the client 100.

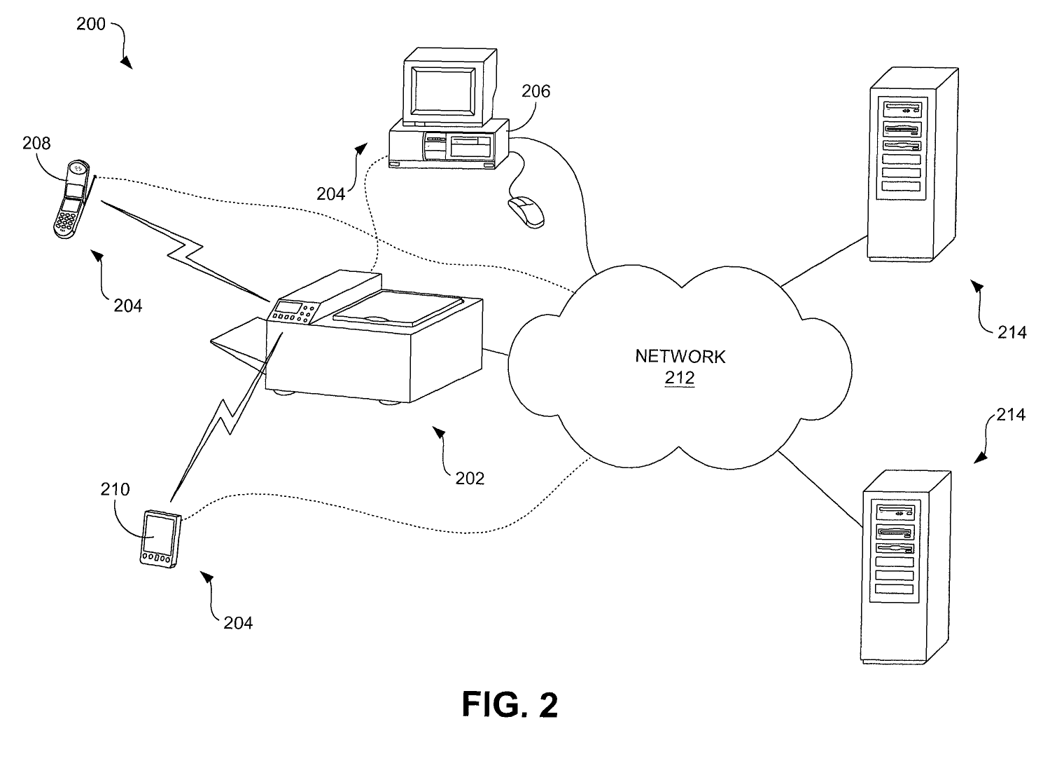

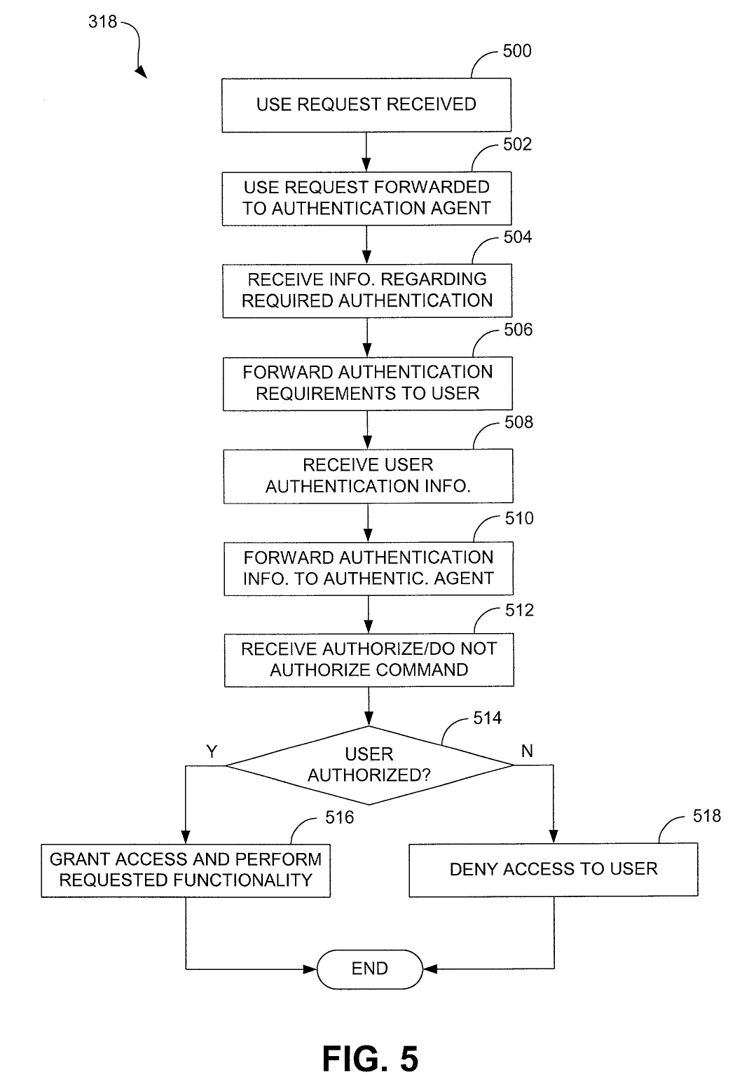

To facilitate description of the invention, an example system will first be discussed with reference to FIGS. 2-4. Although this system is described in detail, it will be appreciated that this system is provided for purposes of illustration only and that various modifications are feasible without departing from the inventive concept. After the example system has been described, examples of operation of the system will be provided with reference to FIGS. 5-7 to explain the manners in which the system may operate.

Referring now to FIG. 2, illustrated is an example system 200 for authenticating use of a network appliance. As indicated in this figure, the system 200 generally comprises a network appliance 202 and one or more computing devices 204 that can access the network appliance. By way of example, the network appliance 202 comprises an appliance that is configured to generate hardcopy printouts such as a printer, photocopier, facsimile machine, multifunction peripheral (MFP) device, etc. However, it is to be understood that the concepts discussed in this disclosure apply equally to substantially any appliance that can be accessed via a network. The computing devices 204 comprise substantially any device that is capable of use with the network appliance 202 and, more particularly, which is capable of communicating with the network appliance by transmitting data to and/or receiving data from the appliance. By way of example, the computing devices 204 can comprise a personal computer (PC) 206, a mobile telephone 208, and a personal digital assistant (PDA) 210. Although specific computing devices are identified in FIG. 2 and discussed herein, it will be appreciated that any one of the computing devices 204 could comprise another type of computing device including, for instance, a notebook computer.

As is further identified in FIG. 2, the system 200 includes a network 212 that typically comprises one or more sub-networks that are communicatively coupled to each other. By way of example, these networks can include one or more local area networks (LANs) and/or wide area networks (WANs). Indeed, in some embodiments, the network 212 may comprise a set of networks that forms part of the Internet. As is depicted in FIG. 2, the network appliance 202 is connected to the network 212. In addition, one or more of the computing devices 204 can be directly connected to the network appliance 202, if desired. Such an arrangement is likely in a home environment in which the user does not have a home network and instead directly communicates to the network appliance 202.

The system 200 further comprises one or more authentication servers 214 which, as indicated in FIG. 2, are likewise connected to the network 212. Accordingly, the network appliance 202 and servers 214 can communicate to each other via the network 212. As described below, the authentication servers 214 are used to confirm the authorization of a user to use (i.e., use the services of) the network appliance 202. Although the term “server” is used, it will be appreciated that alternative arrangements may be used from the discussions that follow.

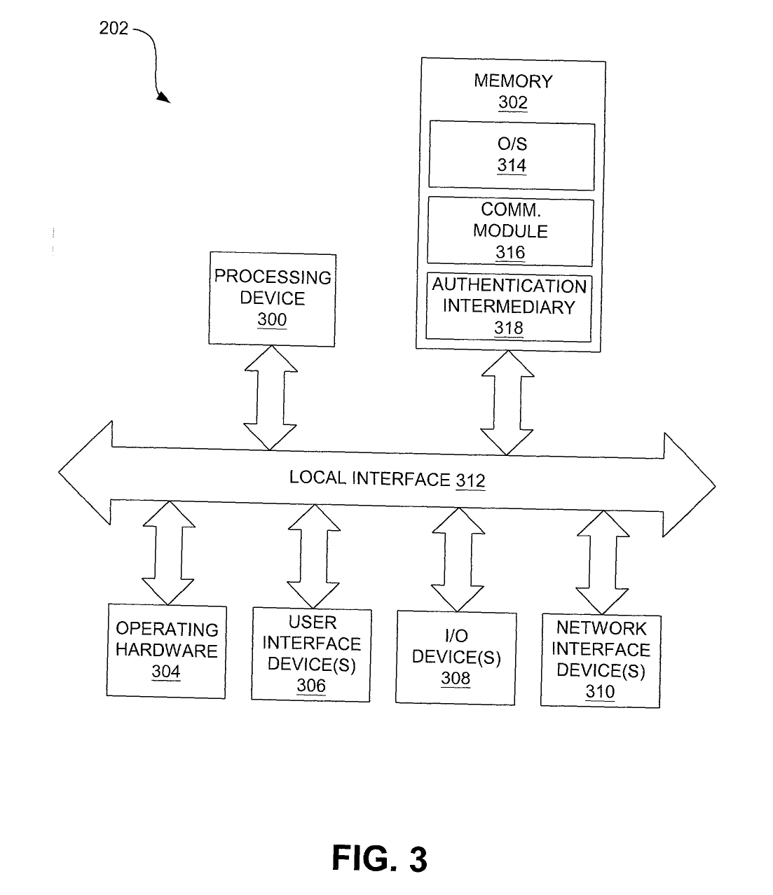

FIG. 3 is a schematic view illustrating an example architecture for the network appliance 202 shown in FIG. 2. As indicated in FIG. 3, the network appliance 202 can comprise a processing device 300, memory 302, operating hardware 304, one or more user interface devices 306, one or more input/output (I/O) devices 308, and one or more network interface devices 310. Each of these components is connected to a local interface 312 that, by way of example, comprises one or more internal buses. The processing device 300 is adapted to execute commands stored in memory 302 and can comprise a general-purpose processor, a microprocessor, one or more application specific integrated circuits (ASICs), a plurality of suitably configured digital logic gates, and other well known electrical configurations comprised of discrete elements both individually and in various combinations to coordinate the overall operation of the network appliance 202.

The operating hardware 304 comprises the components with which the network appliance 202 satisfies its basic functionality. For instance, where the network appliance 202 is adapted to print hardcopies, the operating hardware 304 can include a print engine. When provided, the one or more user interface devices 306 typically comprise interface tools with which the device settings can be changed and through which the user can communicate commands to the network appliance 202. By way of example, user interface devices 306 can include one or more function keys and/or buttons with which the operation of the network appliance 202 can be controlled, and a display, such as a liquid crystal display (LCD), with which information can be visually communicated to the user and, where the display comprises a touch-sensitive screen, commands can be entered.

With further reference to FIG. 3, the one or more I/O devices 308, when provided, are adapted to facilitate connection of the network appliance 202 to another device, such as a computing device 104, and may therefore include one or more serial, parallel, and/or small computer system interface (SCSI) ports. The network interface devices 310 comprise the various components used to transmit and/or receive data over the network 212. By way of example, the network interface devices 310 include a device that can communicate both inputs and outputs, for instance, a modulator/demodulator (e.g., modem), a radio frequency (RF) or other transceiver, a telephonic interface, a bridge, a router, etc.

The memory 302 includes various software (e.g., firmware) programs including an operating system 314, a communications module 316, and an authentication intermediary 318. The operating system 312 contains the various commands used to control the general operation of the network appliance 202. The communications module 316, in conjunction with the network interface devices 310, facilitates communications with other devices via the network 212. As is discussed in greater detail below, the authentication intermediary 318 is configured to pass use requests from a user to a separate authentication agent, and pass authorization requests from the agent to the user. The operation of the authentication intermediary 318 is described with reference to FIG. 5.

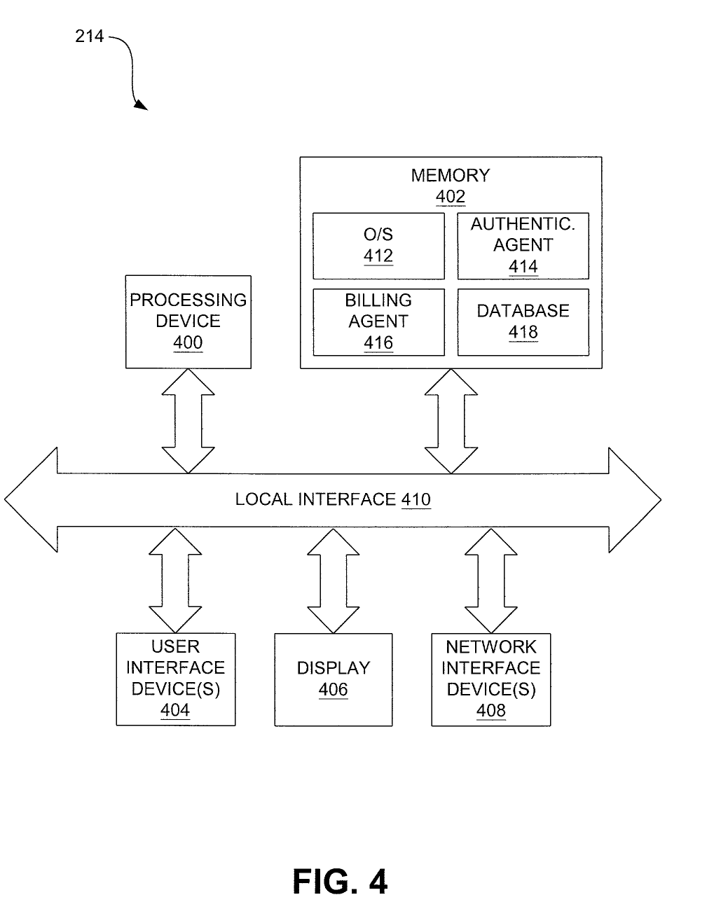

FIG. 4 is a schematic view illustrating an example architecture for the authentication servers 214 shown in FIG. 1. As indicated in FIG. 4, each authentication server 214 can comprise a processing device 400, memory 402, one or more user interface devices 404, a display 406, and one or more networking devices 408, each of which being connected to a local interface 410. The processing device 400 can include any custom made or commercially available processor, a central processing unit (CPU) or an auxiliary processor among several processors associated with the network server 214, a semiconductor based microprocessor (in the form of a microchip), or a macroprocessor. The memory 402 can include any one of a combination of volatile memory elements (e.g., random access memory (RAM, such as DRAM, SRAM, etc.)) and nonvolatile memory elements (e.g., ROM, hard drive, tape, CDROM, etc.).

The one or more user interface devices 404 comprise those components with which the user can interact with the authentication server 214. By way of example, these components comprise those typically used in conjunction with a PC such as a keyboard and mouse. Similarly, the display 406 can comprise a display typically used in conjunction with a PC such as a computer monitor. Like network devices 310, the one or more network devices 408 comprise the various components used to transmit and/or receive data over the network 212 such as a modulator/demodulator (e.g., modem), a radio frequency (RF) or other transceiver, a telephonic interface, a bridge, a router, etc.

The memory 402 normally comprises an operating system 412 and an authentication agent 414. In addition, memory 402 can further comprise a separate payment agent 416. The operating system 412 controls the execution of other software and provides scheduling, input-output control, file and data management, memory management, and communication control and related services. As is discussed in greater detail below, the authentication agent 414 comprises software that is configured to confirm the authorization of users that wish to use the network appliance 202. In addition to these programs, memory 402 can further include a database 418 that is used to determine whether prior authorization exists.

Various software (e.g., firmware) programs have been described herein. It is to be understood that these programs can be stored on any computer readable medium for use by or in connection with any computer related system or method. In the context of this document, a computer readable medium is an electronic, magnetic, optical, or other physical device or means that can contain or store a computer program for use by or in connection with a computer related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

An example system 200 having been described above, operation of the system will now be discussed. In the discussion that follows, flow diagrams are provided. It is to be understood that any process steps or blocks in these flow diagrams represent modules, segments, or portions of code that include one or more executable instructions for implementing specific logical functions or steps in the process. It will be appreciated that, although particular example process steps are described, alternative implementations are feasible. Moreover, steps may be executed out of order from that shown or discussed, including substantially concurrently or in reverse order, depending on the functionality involved.

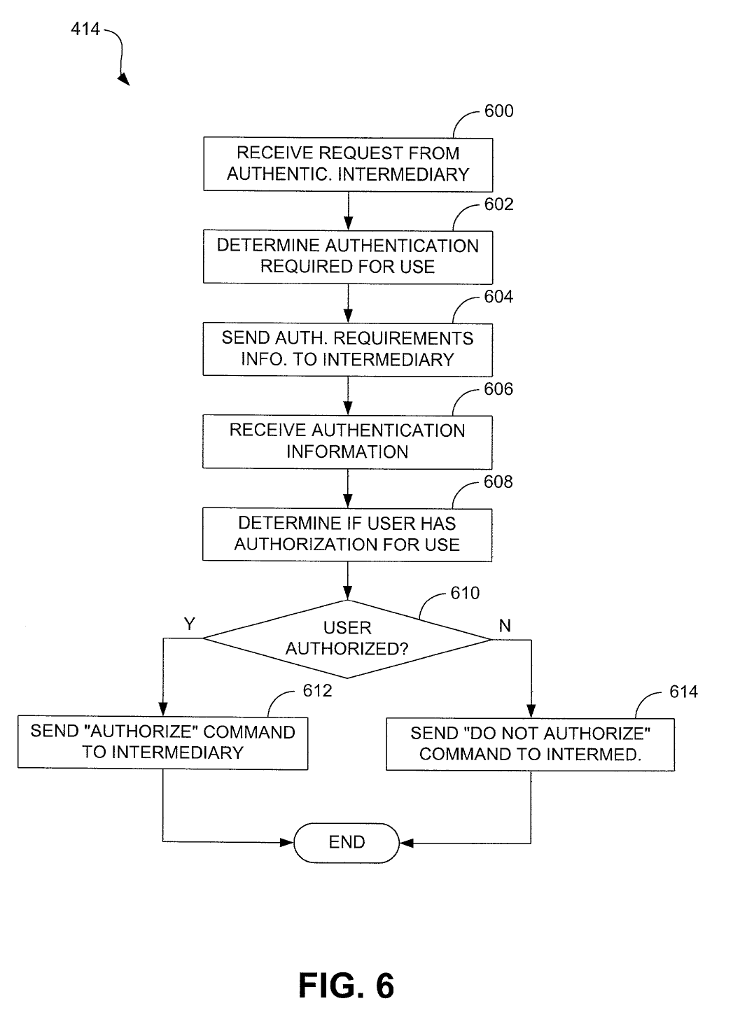

An example of operation of the authentication intermediary 318 of the network appliance 202 will first be discussed with respect to FIG. 5. As indicated in block 500, the authentication intermediary 318 first receives a use request from a potential user. Once the request is received, the use request is forwarded (i.e., transmitted) to the authentication agent 414 of the authentication server 214, as indicated in block 502. As noted below with reference to FIG. 6, the authentication agent 414 determines what authentication is necessary for the use requested by the user. The agent then shares this information with the authentication intermediary 318 which, as indicated in block 504, receives this information regarding the authentication that is required.

At this point, the authentication intermediary 318 forwards the authentication requirements to the user, as indicated in block 506, so as to prompt the user for the user's authentication information. By way of example, the authentication requirements can be transmitted to a display of the user's computing device 204. These requirements can vary depending upon what is considered necessary by the system administrator. By way of example, the authentication information can comprise a user name and password, keyword, code, particular domain, digital certificate, etc. This information can be provided by the user in a variety of ways. For example, the information can be entered into the computing device 104 or directly input into the network appliance 202. In any case, the authentication intermediary 318 can then receive the user's authentication information, as indicated in block 508. Once the information is received, it is forwarded to the authentication agent 414 for consideration, as indicated in block 510.

As described below with reference to FIG. 6, the authentication agent 318 can then determine whether the user has authorization to obtain the services requested of the network appliance 202. Once this occurs, the authentication intermediary 318 can receive an “authorize” or “do not authorize” command from the authentication agent 414, as indicated in block 512, depending upon whether the user's authentication information was acceptable. With reference to decision element 514, it can be determined whether the user is authorized for the requested use based upon the command received from the authentication agent 414. If the use is authorized, flow continues to block 516 at which access is granted to the network appliance 202 and the requested functionality is performed for the user. As will be appreciated by persons having ordinary skill in the art, the network appliance 218 can be made generally available to the user, or only certain functionalities of the appliance can be made available depending upon the level of the user's authorization. If the user is not authorized, however, flow continues to block 518 at which access is denied to the user. In either case, flow for the session is terminated.

If the user did not obtain access, e.g. the user mistakenly entered the wrong authentication information, the user can again attempt to gain access by beginning with block 500 and repeating the flow described above. As can be appreciated from the above discussion, the authentication intermediary 318 acts in the capacity of an intermediary, i.e., it merely passes requests, commands, and other information between the user and the authentication agent 414. Because of this arrangement, the configuration of the network appliance 202 can be greatly simplified. Moreover, authentication can be standardized for all network appliances, irrespective of the underlying operating environment, in that authentication is controlled by a separate, centralized entity: the authentication agent 414.

Although the above example identifies the steps of receiving information about what authentication is required, forwarding this information to the user, receiving the information, and forwarding it on to the authentication agent 414, persons having ordinary skill in the art will appreciate that where the user already knows what authentication is required (e.g., where the user is a regular user), this information can be provided to the authentication intermediary 218 along with the initial use request to simplify and expedite the authentication process. The flow described in FIG. 5 is advantageous, however, where the user does not know what form of authentication information will be required by the authentication agent 414 (e.g., where the user is a visiting user).

Referring now to FIG. 6, an example of operation of the authentication agent 414 of the authentication server 214 will now be discussed. Beginning with block 600, the authentication agent 414 first receives the use request that is forwarded by the authentication intermediary 218 in the manner described above with reference to FIG. 5. Once this request is received, the authentication agent 414 can determine what form of authentication is required to access and use of the network appliance 202, as indicated in block 602. Where the use request identifies a particular functionality desired from the appliance, the authentication agent 414 can furthermore determine what form of authentication is required for that particular use, if desired. As noted above, various different types of authentication information can be required of the user.

With reference to block 604, the authentication agent 414 then forwards the authentication requirements information to the authentication intermediary 318 of the network appliance 202. After this information has been sent, the authentication agent 414 can receive the authentication information that has been provided by the user to the authentication intermediary 318, as indicated in block 606. Once this information is received, the authentication agent 414 can determine whether the user has adequate authorization, as indicated in block 608, by determining whether the authentication information that has been provided is acceptable. This determination can, for instance, be made by referencing the database 418 which stores a list of what information is required. As noted above, the authentication information required may vary based upon the type of use that is requested. For example, where the network appliance 202 has a fax functionality, different authentication information may be required for long-distance faxing as opposed to local faxing.

With reference to decision element 610, if the user is authorized, flow continues on to block 612 at which the authentication agent 414 sends an “authorize” command to the authentication intermediary 318 of the network appliance 202. If no such authorization exists, however, flow continues from decision element 610 to block 614 at which a “do not authorize” command is sent to the authentication intermediary 318. At this point, flow is terminated.

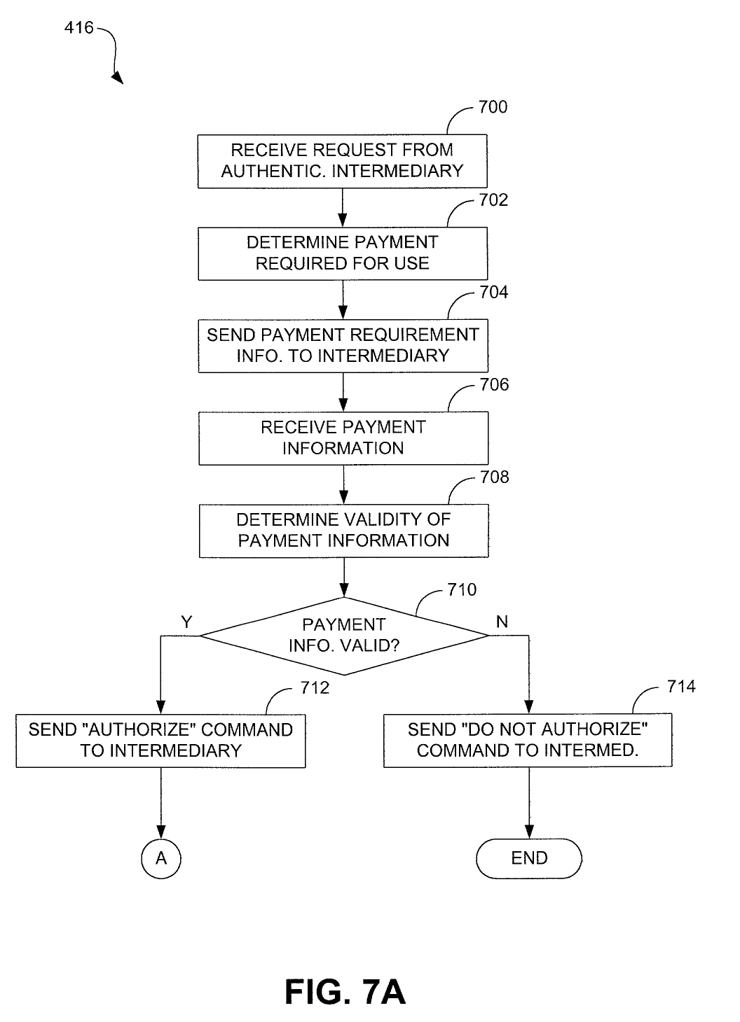

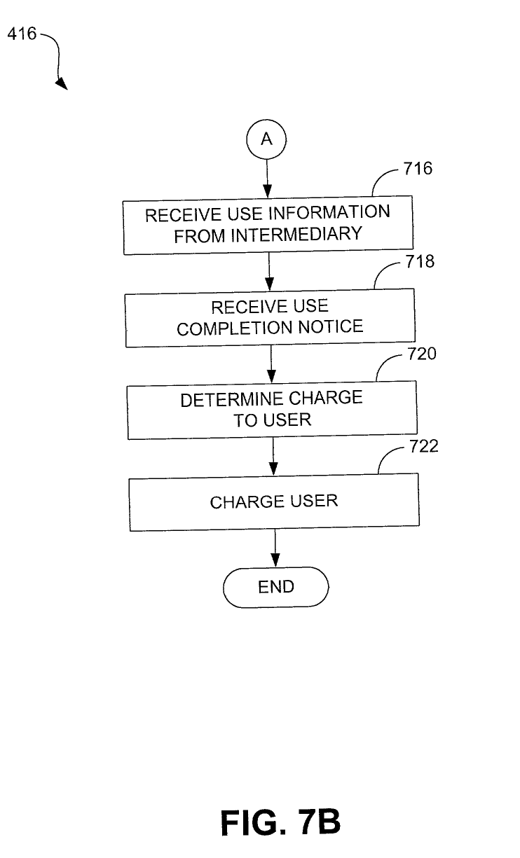

In addition to authenticating use of the network appliance 202, the system 200 can further be used to control billing for use of the appliance. Such billing could apply in addition to authentication of the use (e.g., in an office environment) or could be independent of such authentication (e.g., in a public environment). Regardless, such billing control can be provided by the billing agent 416 of the authentication server 214. FIGS. 7A and 7B illustrate an example of operation of the billing agent 416. As will be evident from the discussion that follows, flow is similar to that involved with the authentication process described above in relation to FIG. 6. In this discussion, communications are described as again being forwarded by the authentication intermediary 318 of the network appliance 202. It will be understood, however, that this forwarding could, alternatively, be conducted by a separate billing intermediary, if desired. However, in that the intermediary 318 merely functions to pass along information it receives, a separate intermediary is not necessary in most cases. In that operation of the intermediary 318 is substantially the same whether facilitating authentication or billing, the operation of the intermediary in the billing scenario is not discussed in detail herein.

Referring to block 700 of FIG. 7A, the billing agent 416 first receives the use request that is forwarded by the authentication intermediary 318 in the manner described above with reference to FIG. 5. Once this request is received, the billing agent 416 can determine what type of payment is required for use of the network appliance 202, as indicated in block 702. For example, the billing agent 416 may be configured to require a billing number that pertains to a corporate employee's division or, in the public context, a credit card number. The billing agent 416 then forwards the payment requirement information to the intermediary 318, as indicated in block 704, and therefore to the potential user of the network appliance 202. After this information has been sent, the billing agent 416 can receive the user's payment information, as indicated in block 706 (again forwarded by the intermediary 318).

Once the payment information is received, the billing agent 416 can determine whether the payment information is valid, as indicated in block 708. Generally speaking, this may comprise determining whether the form of payment selected by the user is acceptable and whether the user has sufficient rights (e.g., funds) in association with this form of payment (e.g., account). The first of these determinations can be made with reference to the database 418, while the second of these determinations can be made in conventional manner in the art (e.g., by accessing a remote database concerning the status of a selected account).

With reference to decision element 710, if the payment information is valid, flow continues on to block 712 at which the billing agent 416 sends an “authorize” command to the intermediary 318 of the network appliance 202. If no such authorization exists, however, flow continues from decision element 710 to block 714 at which a “do not authorize” command is sent to the intermediary 318. Where authorization is present, flow continues to block 716 of FIG. 7B. As indicated in this figure, the payment agent 414 can receive use information from the intermediary 318. This information comprises information concerning use of the appliance relevant to billing. For example, where the network appliance comprises a photocopier, the information can comprise the number of copies that have been made. Although the periodic receipt of such information prior to job completion is useful where the amount due is to be tracked against the amount available for “spending,” it is to be understood that this information could, alternatively, be provided to the billing agent 416 only upon completion of the use.

Once use is completed, the billing agent 416 receives a completion notice from the intermediary 318, as indicated in block 718. Completion can be communicated to the intermediary 318 by, for instance, selection of a “complete” button (or other key which signals this condition) by the user or mere discontinuation of use. In any case, the billing agent can at this time determine what the charge is to the user, as indicated in block 720. As will be appreciated by persons having ordinary skill in the art, this determination can be made with reference to the use information relative to a cost schedule (price list) stored on the database 418. At this point, the user's account can be charged the appropriate amount, as indicated in block 722, in conventional fashion.

While particular embodiments of the invention have been disclosed in detail in the foregoing description and drawings for purposes of example, it will be understood by those skilled in the art that variations and modifications thereof can be made without departing from the scope of the invention as set forth in the following claims. For instance, it is to be appreciated that all communications could be secure using general know security methods.

What is claimed is:

1. A method for authenticating use of a network appliance, comprising the steps of:
receiving a use request from a user;
forwarding the request to an authentication agent configured to determine whether the user is authorized to use the network appliance;
receiving an indication from the authentication agent as to whether the user is authorized; and
enabling or disabling use of the network appliance by the user based upon the indication received from the authentication agent.

2. The method of claim 1, wherein the step of forwarding the request comprises forwarding the request to an authentication agent residing on a remote computing device via a network.

3. The method of claim 1, further comprising the step of receiving an indication of authentication information required to use the network appliance from the authentication agent.

4. The method of claim 3, further comprising the step of forwarding the indication of the required authentication information to the user.

5. The method of claim 1, further comprising the step of receiving authentication information from the user.

6. The method of claim 5, further comprising the step of forwarding the authentication information to the authentication agent.

7. A network appliance, comprising:
means for receiving a use request from a user;
means for transmitting the request to an authentication agent configured to determine whether the user is authorized to use the network appliance;
means for receiving an indication from the authentication agent as to whether the user is authorized; and
means for enabling or disabling use of the network appliance by the user based upon the indication received from the authentication agent.

8. A method for authenticating use of a network appliance, comprising the steps of:
receiving a request to use the network appliance;
determining whether the user has authorization to use the network appliance; and
forwarding an indication to the network appliance as to whether the user has authorization.

9. The method of claim 8, wherein the step of receiving a request comprises receiving a use request from the network appliance.

10. The method of claim 8, further comprising the step of determining authentication information required to use the network appliance.

11. The method of claim 10, further comprising the step of forwarding an identification of the authentication information required to the network appliance.

12. The method of claim 8, further comprising the step of receiving authentication information of the user from the network appliance.

13. A system for authenticating use of a network appliance, comprising:
means for receiving a request to use the network appliance;
means for determining whether the user has authorization to use the network appliance; and
means for transmitting an indication to the network appliance as to whether the user has authorization.

14. A method for authenticating use of a network appliance, comprising the steps of:
receiving a request to use the network appliance;
receiving payment information of a user that initially made the request;
determining whether the payment information is valid; and
forwarding an indication to the network appliance as to whether the user has authorization to use the device based upon the validity of the payment information.

15. The method of claim 14, wherein the step of receiving a request comprises receiving a use request from the network appliance.

16. The method of claim 14, further comprising the step of determining the type of payment information required to use the network appliance.

17. The method of claim 16, further comprising the step of forwarding an identification of the type of payment information required to the network appliance.

18. The method of claim 14, wherein the step of receiving payment information comprises receiving payment information from the network appliance.

19. The method of claim 14, further comprising the step of receiving use information from the network information.

20. The method of claim 19, further comprising the steps of determining the charge to the user based upon the use information and charging the user for use of the network appliance.
